(19) United States
(12) Patent Application Publication
(10) Pub. No.: US 2022/0301455 A1
(43) Pub. Date: Sep. 22, 2022

(54) THROUGH THE LOCK C SYSTEM

(71) Applicant: Coire WILLIAMS, East Orange, NJ (US)

(72) Inventor: Coire WILLIAMS, East Orange, NJ (US)

(21) Appl. No.: 17/696,711

(22) Filed: Mar. 16, 2022

Related U.S. Application Data
(60) Provisional application No. 63/162,735, filed on Mar. 18, 2021.

(51) Int. Cl. G09B 19/24; E06B 3/82; E06B 5/00

(52) U.S. Cl. CPC G09B 19/24; E06B 3/82; E06B 5/00

(57) ABSTRACT

A reusable apparatus for conducting through-the-lock training, which is adapted to simulate locked doors is provided, along with systems, kits, and methods of use.

### CROSS-REFERENCE TO RELATED APPLICATIONS

This application claims priority to U.S. Provisional Patent Application No. 63/162,735, filed Mar. 18, 2021, the contents of each of which are hereby incorporated by reference in their entirety.

### TECHNICAL AREA

The present invention is an apparatus for emergency personnel/first responders, such as firefighters, to train and develop the skill sets required for entry of locked points of entry and egress.

### Background

For First Responders, firefighters for example, many circumstances arise in which entry must be made into a locked space. The space could be commercial or residential, occupied or vacant, high rise or single story or below grade. It could have wood doors, metal doors, or glass doors. It could be a front door, back door, side door, bulkhead door, garage door, roll up door, bedroom or closet door, a window, an elevator. These points of entry/egress often have some form of security hardware that range from basic locks and latches to high security electronic, magnetic, and even digital locking assemblies. There is a great range of emergencies in which first responders are called upon to gain entry into these spaces, including, for example, structure fires, trapped people or animals, water leaks, gas leaks, electrical conditions, lift assists, apartment lockouts with food on the stove, child or immobile person locked inside, smoke alarm activations, and so forth. Some emergencies threaten immediate life safety. In these emergencies, preserving life is of higher priority than preserving property, and any locking devices and barriers must be defeated and are damaged. In other emergencies, however, life or health of occupants is not in immediate danger, and competency in bypassing locking devices with minimal property damage is very important to the first responder. As such, in depth training of first responders to enter locked space with speed and efficiency, while minimizing property damage, is very useful. The present invention addresses these and other needs in the art.

### SUMMARY

In certain embodiments an apparatus is provided comprising a working section door prop, wherein the working section door prop comprises a door frame and a bracket rotatably attached to the door frame; a door panel, wherein the door panel is adapted to be mountably received by the bracket such that the door panel is secured by the bracket; and a lock assembly comprising a lock assembly secured in the door panel, wherein the door frame is adapted to accept a plurality of types of lock assembly at one or more discreet locations.

Frequently a rotation of the rotatably attached bracket is at least 30 degrees, at least 40 degrees, at least 50 degrees, at least 60 degrees, at least 70 degrees, at least 80 degrees, at least 90 degrees, at least 100 degrees, at least 110 degrees, at least 120 degrees, at least 130 degrees, at least 140 degrees, at least 150 degrees, at least 160 degrees, at least 170 degrees, or at least 180 degrees.

In certain embodiments the door panel is secured in a track formed by the bracket. The bracket forms a track is frequently adapted to removably receive the door panel.

In certain embodiments the door panel is attached to the bracket by an attachment mechanism.

Often the bracket is C-shaped such that when a square door panel is secured in the bracket, the door frame is contacting, connected with, or secured by at least a portion of three sides of the square door panel.

Also often the adaptation of the door frame to accept the plurality of types of lock assemblies comprises permitting reversibly securable closure and interface of the door panel with the door frame. The door panel is frequently secured by the bracket without additional hardware.

In frequent embodiments the working section door prop is mounted on a post or other mounting hardware. Often one or more additional working section door props are mounted on the post or other mounting hardware. Often, one or more working section is adapted to be removably attached to the mounting post. Often, two or more working sections are adapted to be removably attached to the mounting post. Often, three or more working sections are adapted to be removably attached to the mounting post. Also often, the post is adapted to be removably attached to one or more working sections, or two or more working sections.

A training system is also frequently provided, comprising the apparatus, one more additional door panel, and one or more additional lock assembly. Often the training system includes two more additional door panels and/or two or more additional lock assemblies.

These and other embodiments, features, and advantages will become apparent to those skilled in the art when taken with reference to the following more detailed description of various exemplary embodiments of the present disclosure in conjunction with the accompanying drawings.

### LIST OF INCLUDED DRAWINGS

The skilled person in the art will understand that the drawings, described below, are for illustration purposes only.

FIG. 1 is a schematic, outward swinging plane view of the “Working Section” of the through-the-lock training apparatus according to an exemplary embodiment of the invention.

FIG. 2 is a schematic, outward swinging perspective view of the “Working Section” of the through-the-lock training apparatus according to an exemplary embodiment of the invention.

FIG. 3 is a schematic, outward swinging perspective view of the “Working Section” of the through-the-lock training apparatus, in an opened position, according to an exemplary embodiment of the invention.

FIG. 4 is a schematic, outward swinging perspective view of the “Working Section” of the through-the-lock training apparatus, in an opened position with simulated door panel being removed from the “C” System bracket, according to an exemplary embodiment of the invention.

FIG. 5 is a schematic, outward swinging perspective view of the “Working Section” of the through-the-lock training apparatus, in an opened position with simulated door panel removed, according to an exemplary embodiment of the invention.

FIG. 6 is a schematic, outward swinging perspective view of the “Working Section” of the through-the-lock training apparatus, in an opened position with simulated door panel removed, according to an exemplary embodiment of the invention.

FIG. 7 is a schematic, inward swinging perspective view of the “Working Section” of the through-the-lock training apparatus according to an exemplary embodiment of the invention.

FIG. 8 is a schematic, inward swinging perspective view of the “Working Section” of the through-the-lock training apparatus, in the open position with simulated door panel removed, according to an exemplary embodiment of the invention.

FIG. 9 is a schematic, inward swinging perspective view of the “Working Section” of the through-the-lock training apparatus, with commercial lock assemblies, according to an exemplary embodiment of the invention.

FIG. 10 is a schematic, inward swinging perspective view of the “Working Section” of the through-the-lock training apparatus, with residential lock assemblies, according to an exemplary embodiment of the invention.

FIG. 11 is a schematic, inward swinging perspective view of the “Working Section” of the through-the-lock training apparatus, with residential lock assemblies, according to an exemplary embodiment of the invention.

FIG. 12 is a schematic, outward swinging perspective view of the “Working Section” of the through-the-lock training apparatus, with commercial lock assemblies, according to an exemplary embodiment of the invention.

FIG. 13 is a schematic, outward swinging perspective view of the “Working Section” of the through-the-lock training apparatus, with commercial lock assemblies, according to an exemplary embodiment of the invention.

FIG. 14 is a schematic, outward swinging perspective view of the “Working Section” of the through-the-lock training apparatus, with commercial lock assemblies, according to an exemplary embodiment of the invention.

FIG. 15 is a schematic, outward swinging perspective view of the “Working Section” of the through-the-lock training apparatus, with residential lock assemblies, according to an exemplary embodiment of the invention.

FIG. 16 is a schematic, outward swinging perspective view of the “Working Section” of the through-the-lock training apparatus, with residential lock assemblies, according to an exemplary embodiment of the invention.

FIG. 17 is a schematic, outward swinging perspective view of the “Working Section” of the through-the-lock training apparatus, with residential lock assemblies, according to an exemplary embodiment of the invention.

FIG. 18 is a schematic, outward swinging perspective view of the “Working Section” of the through-the-lock training apparatus, with commercial lock assemblies, according to an exemplary embodiment of the invention.

FIG. 19 is a schematic, outward swinging perspective view of the “Working Section” of the through-the-lock training apparatus, with commercial lock assemblies, according to an exemplary embodiment of the invention.

FIG. 20 is a schematic, outward swinging perspective view of the “Working Section” of the through-the-lock training apparatus, with digital lock assemblies, according to an exemplary embodiment of the invention.

FIG. 21 is a schematic, outward swinging perspective view of the “Working Section” of the through-the-lock training apparatus, with residential lock assemblies, according to an exemplary embodiment of the invention.

FIG. 22 is a schematic, inward swinging perspective view of the “Working Section” of the through-the-lock training apparatus, with residential lock assemblies, according to an exemplary embodiment of the invention.

FIG. 23 is a schematic plain view of the of a system comprising through-the-lock training apparatus according to an exemplary embodiment of the invention.

FIG. 24 is a schematic perspective view of a system comprising the through-the-lock training apparatus according to an exemplary embodiment of the invention.

FIG. 25 is a schematic perspective view of the hinge orientation of a system comprising the through-the-lock training apparatus according to an exemplary embodiment of the invention.

FIG. 26 is a schematic, outward swinging perspective view of the strike plate and upper rabbet lock assemblies, on a system comprising the through-the-lock training apparatus according to an exemplary embodiment of the invention.

FIG. 27 is a schematic, inward swinging plain view of a system comprising the through-the-lock training apparatus, showing the spaces between the stop and the jamb simulating scenarios during which, in wood jamb/stop construction, the stop can be pried away from the jamb to provide space to insert a blade like tool to swipe the latch, according to an exemplary embodiment of the invention.

### DETAILED DESCRIPTION

For clarity of disclosure, and not by way of limitation, the detailed description of various embodiments is divided into certain subsections that follow.

Unless defined otherwise, all technical and scientific terms used herein have the same meaning as is commonly understood by one of the ordinary skill in the art to which this disclosure belongs. All patents, applications, published applications and other publications referred to herein are incorporated by reference in their entirety. If a definition set forth in this section is contrary to or otherwise inconsistent with a definition set forth in the patents, applications, published applications and other publications that are herein incorporated by reference, the definition set forth in this section prevails over the definition that is incorporated herein by reference.

As used herein, “a” or “an” means “at least one” or “one or more.”

As used herein, the term “and/or” may mean “and,” it may mean “or,” it may mean “exclusive-or,” it may mean “one,” it may mean “some, but not all,” it may mean “neither,” and/or it may mean “both.”

As used herein, the term “C-shaped” or “C System” are intended to refer to a bracket concept rather than requiring a specific bracket shape. As such C-shaped and C System encompass brackets that are in the shape of the letter “C” in any form, whether straight edges are included or if portions of the, or the entire, shape of the bracket is curved. Other shaped brackets are contemplated and the depicted and described embodiments are merely for purposes of describing and illustrating the concept. In this regard the C System embodiments described herein encompass L-shaped, V-shaped, W-shaped, and/or I-shaped brackets, among a variety other shapes contemplated without limitation. Moreover, a collection of two or more brackets operating in tandem with a door panel may be combined in a single embodiment of the C System of the present disclosure.

As used herein “working section” refers to an apparatus of the present disclosure including a bracket, frame, panel, and hardware.

As used herein, “lock assembly” refers to any door hardware used to open/close and/or lock/secure residential and/or commercial doors. A person of ordinary skill in the art would appreciate the scope of the term “assembly” in this regard such that its meaning is not appropriately limited to embodiments specifically depicted and described herein.

In an emergency with no immediate life danger, first responders often resort to forcible entry techniques that cause significant property damage, if they are not equipped with sufficient training. The firefighter, for example, will use the irons (e.g., flat head axe paired with halligan bar) to form a gap between the door locking assembly and door frame, drive the halligan bar through the gap by striking it with the flat head axe. Then, using the doorframe for leverage, force the door open by pushing or pulling the halligan bar. This sequence is an example of forcible entry techniques that causes significant damage to the door, doorframe, as well as the locking assembly. The result is a significant burden for the property owner to replace or repair the damage and restore security.

Sufficient training can reduce or prevent this property damage. Using the apparatus described herein, first responders can learn to defeat entry point locks and, gain entry/egress, with any damage being isolated to the lock assembly itself. This significantly decreases the financial burden on the property owners and does not inhibit the speed with which first responders perform their duties. In some cases, defeating the lock can be done in such a way that the lock assemblies maintain the appearance of being secure.

Exemplary embodiments of the present disclosure include an optionally portable and reusable through-the-lock training prop adapted to simulate locked doors. All embodiments contemplate both inward and outward swinging doors with one or the other described for exemplary purposes only. The present apparatus also permits users to train through-the-lock skills on numerous types of doors and door frames (e.g., wood, metal, glass, composite, fiberglass, plastic, etc.) having any variety of types of lock assemblies, including residential and commercial. As such, the presently described systems feature versatile and adaptable, permitting a user to switch out different components such as doors, door frames and lock assemblies in a single system.

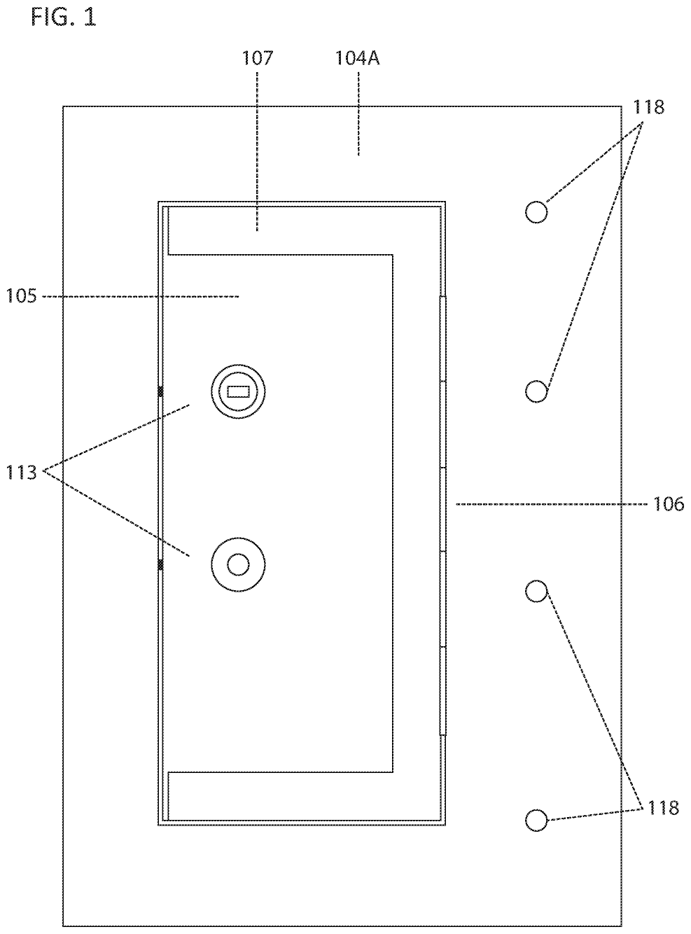

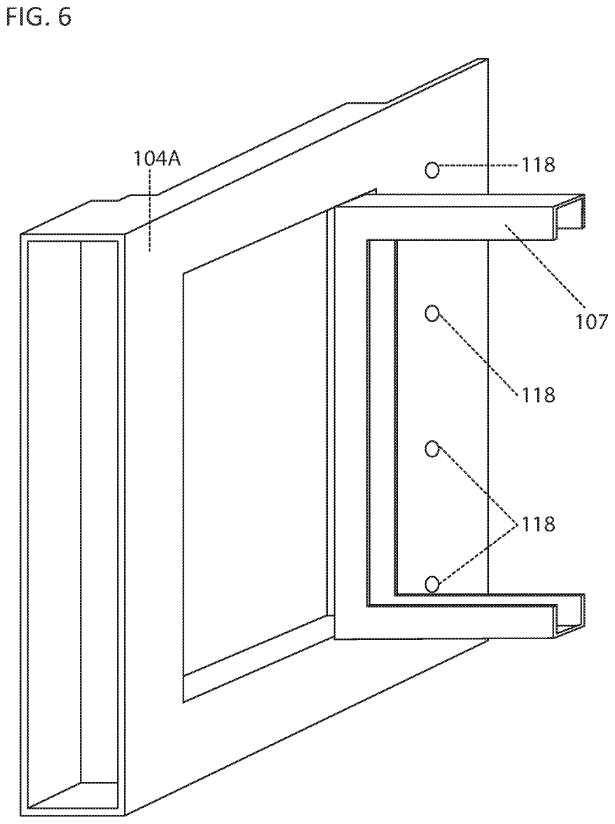

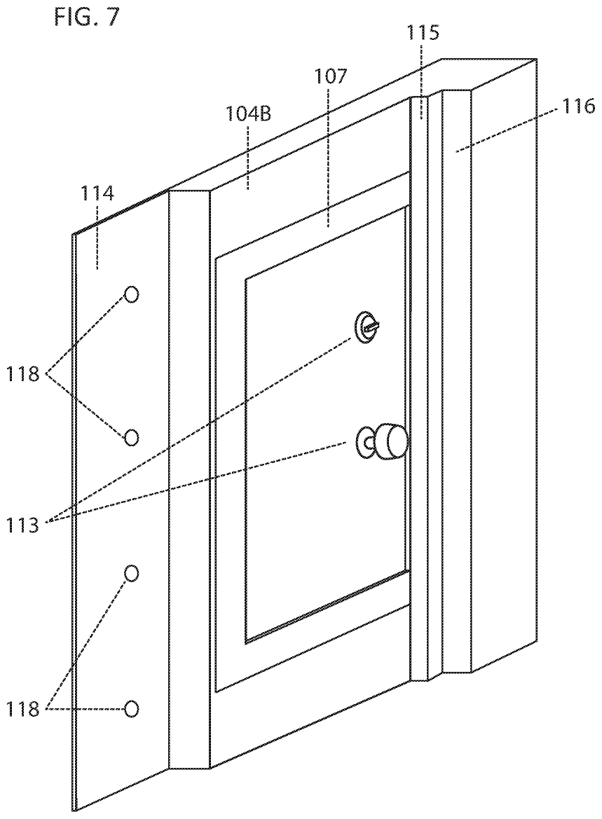

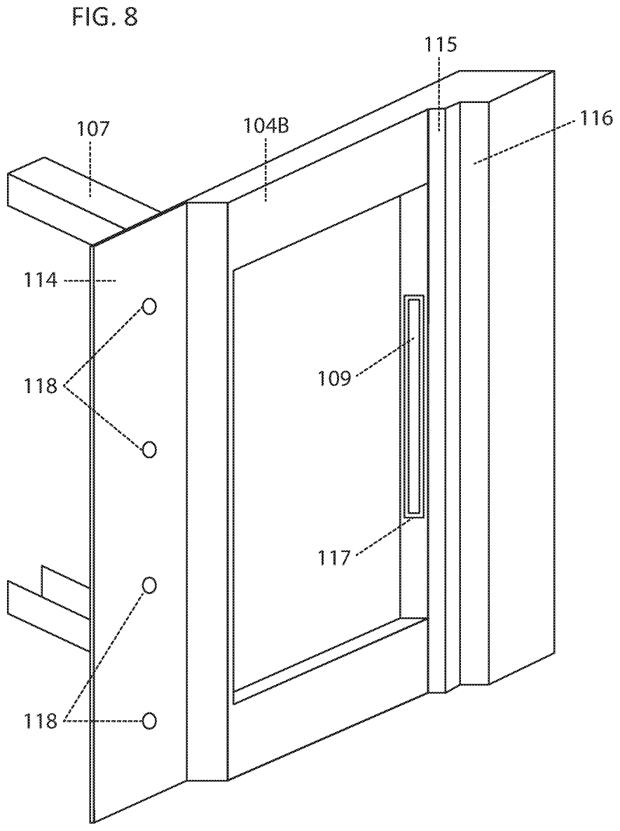

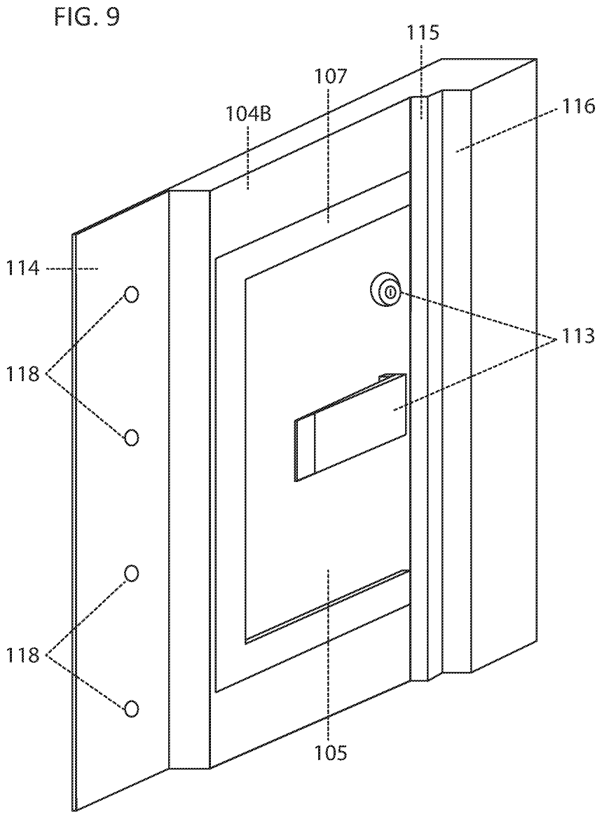

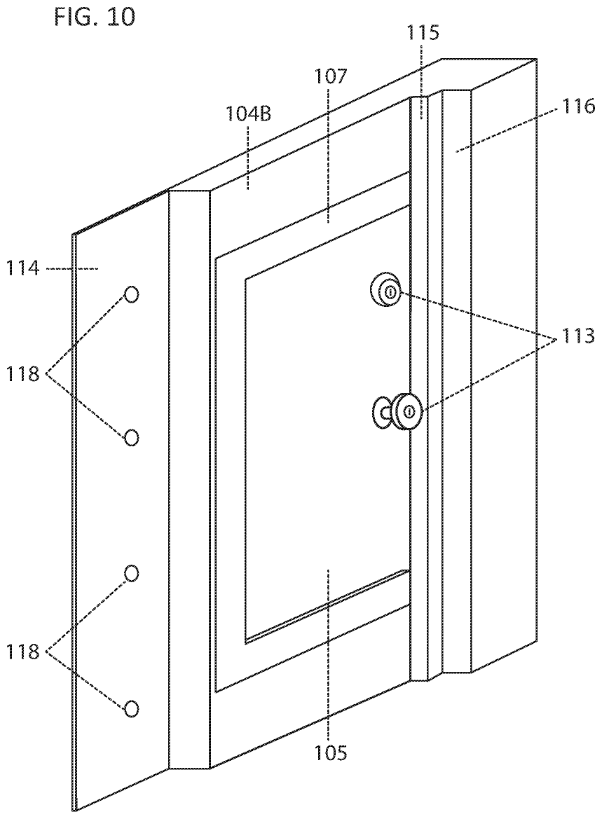

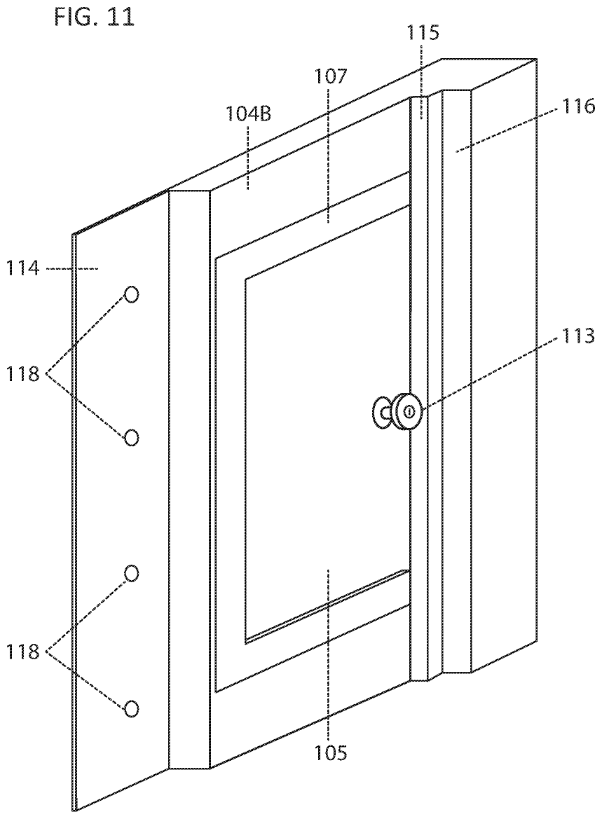

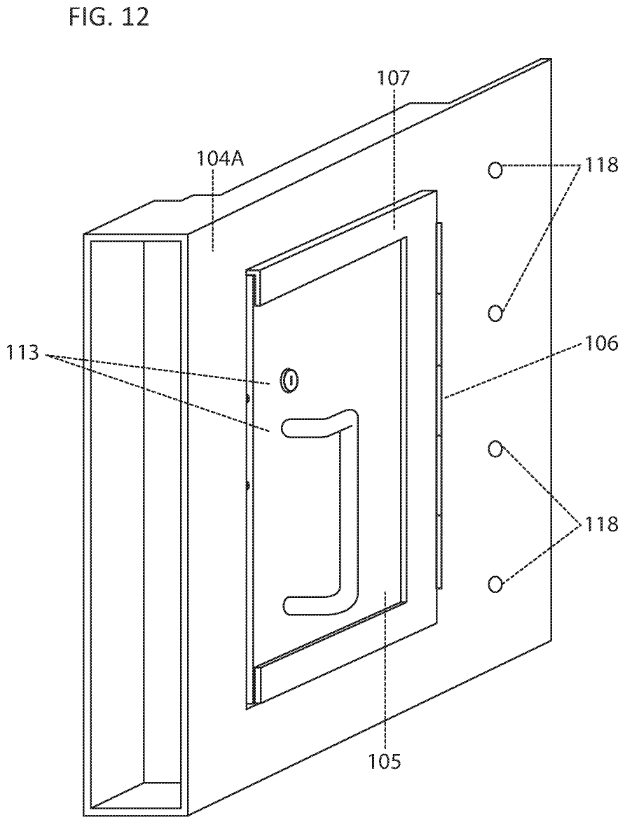

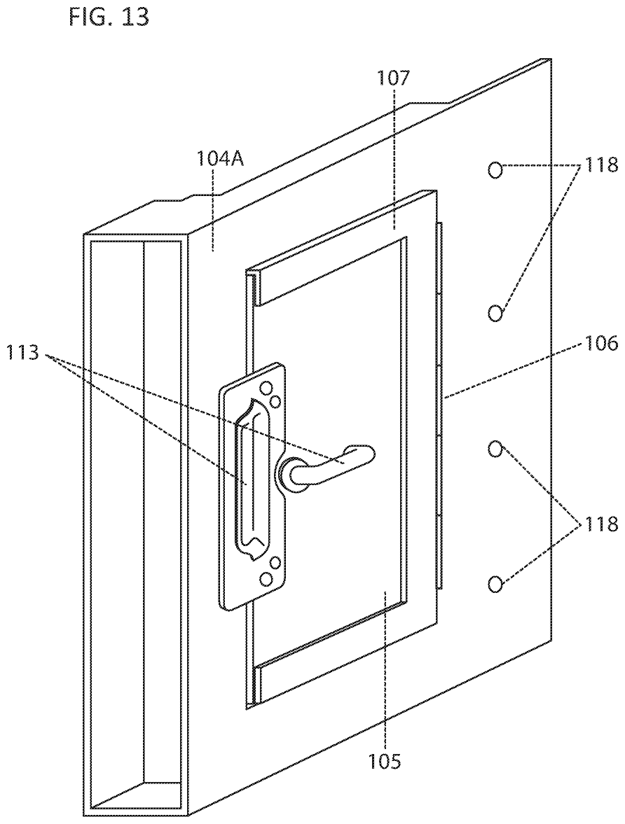

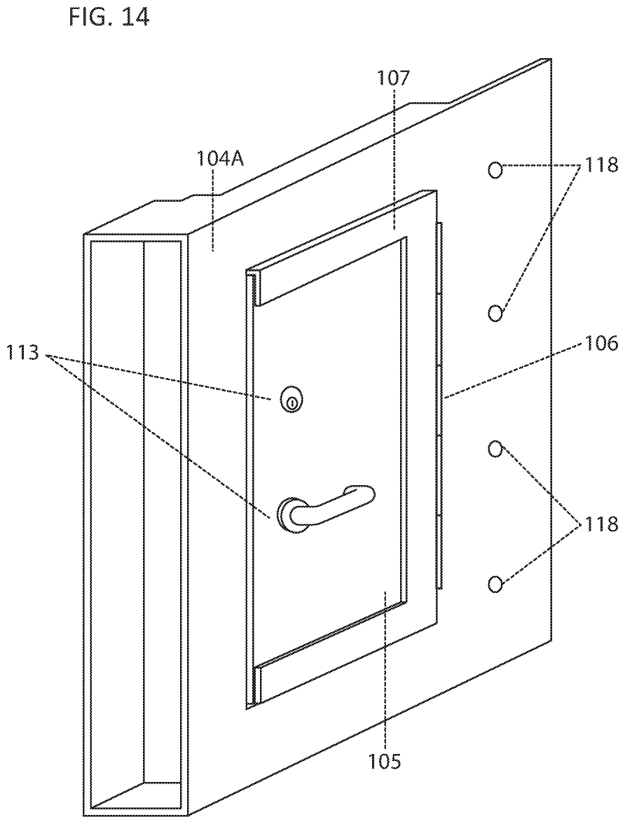

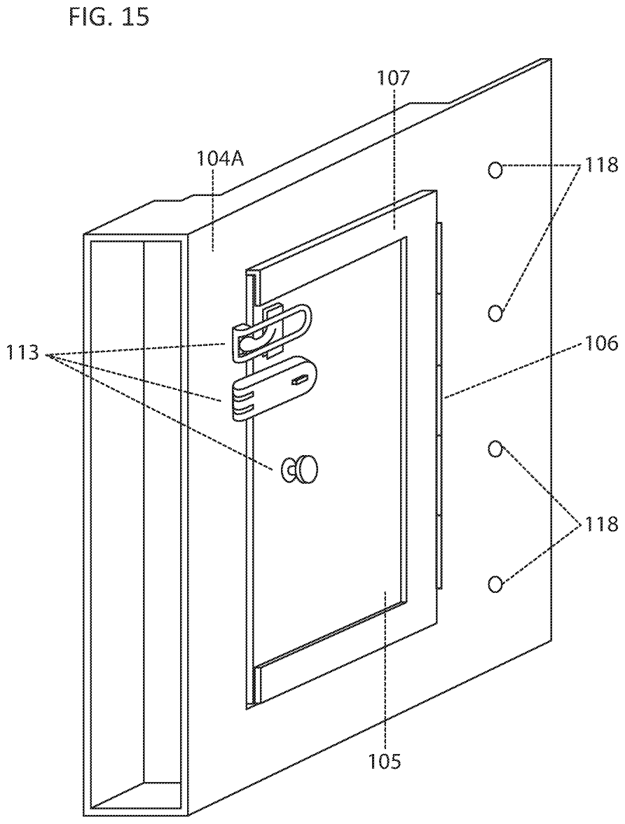

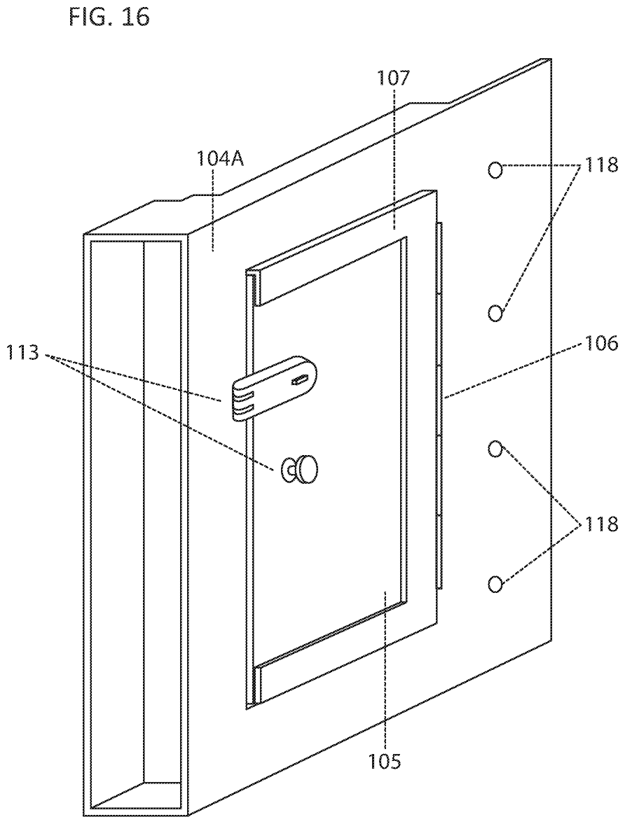

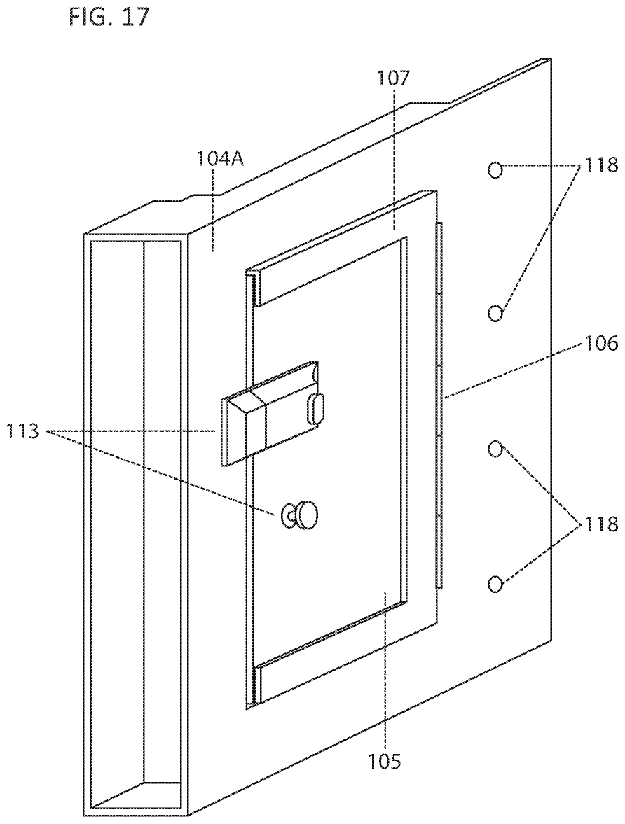

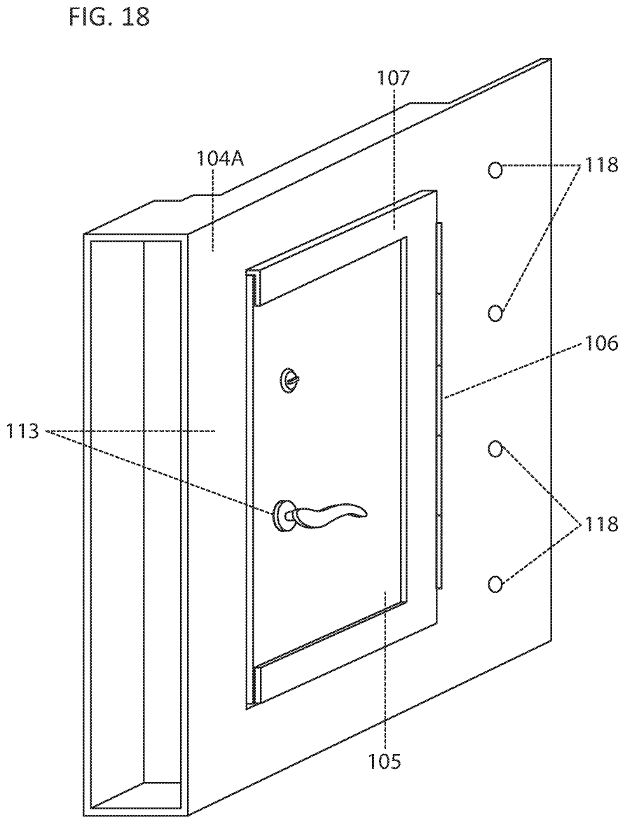

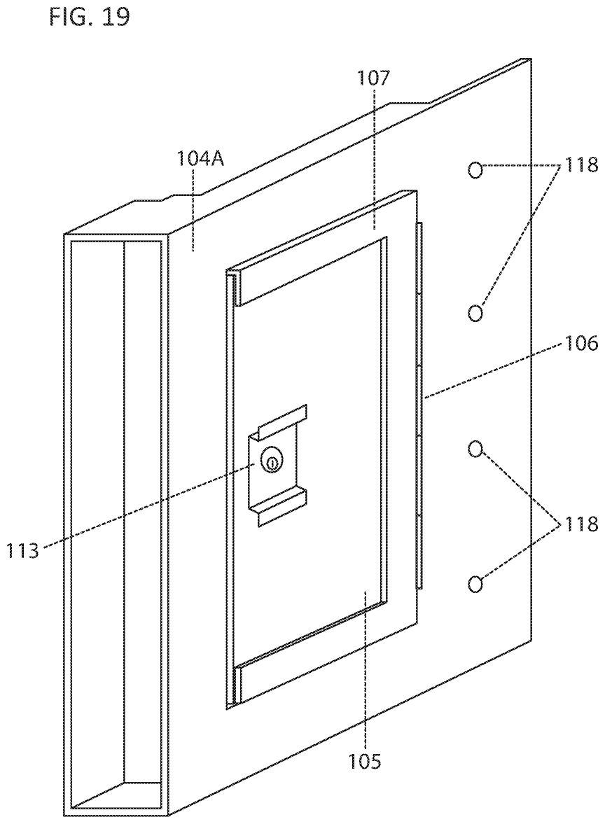

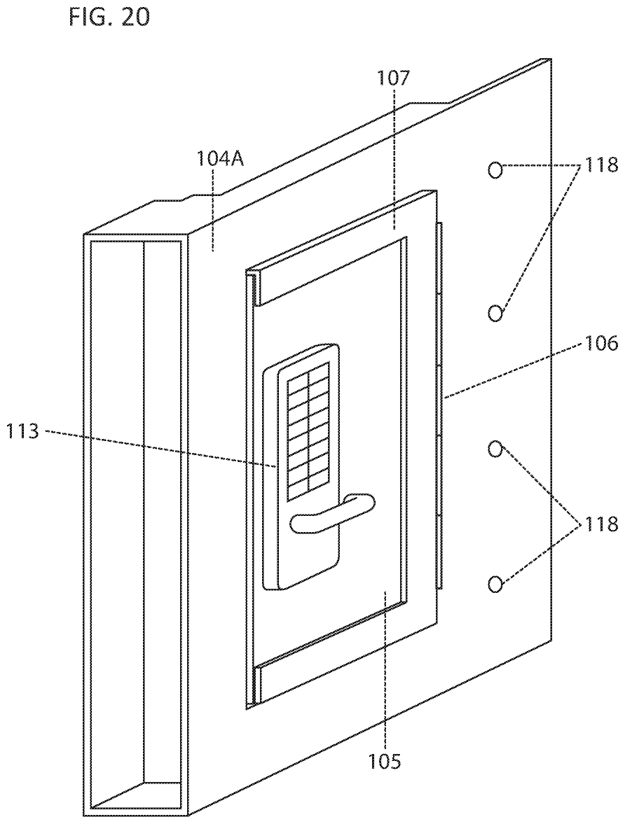

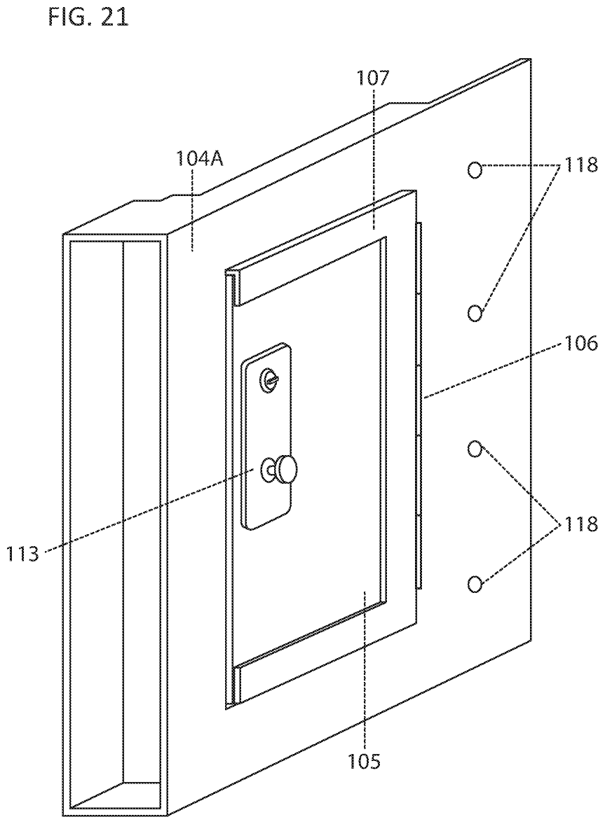

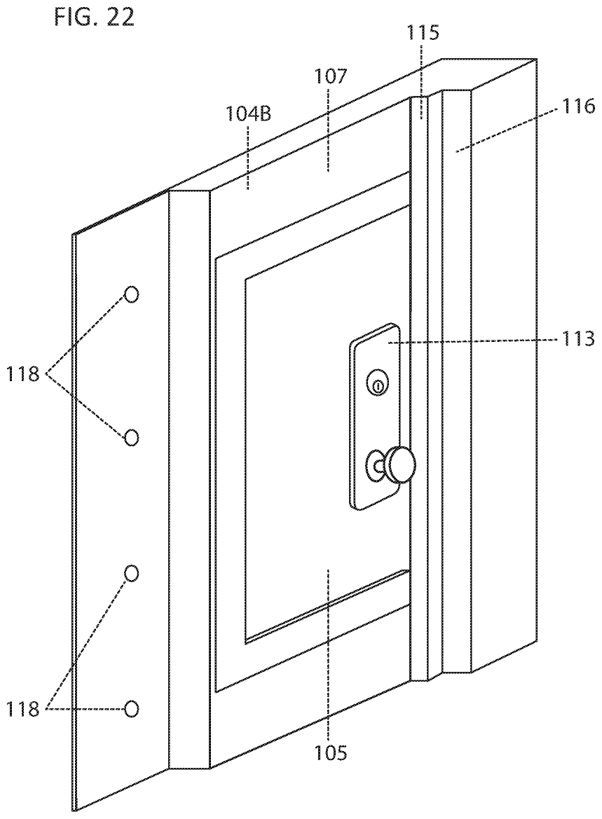

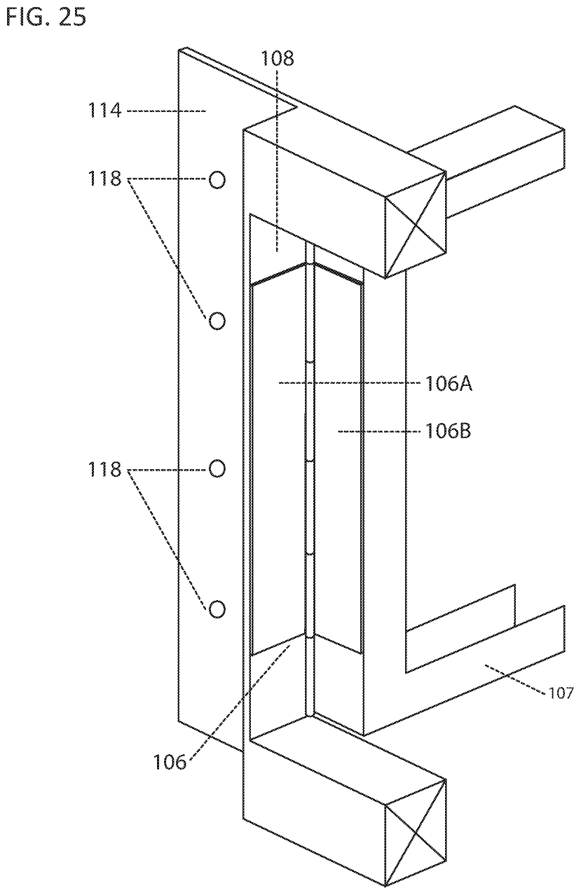

The presently provided apparatus and systems provide realistic presentation and in certain embodiments scale as well. For example, as depicted in FIGS. 1-27, the working section of the present systems, provide a representation of an isolated area of the frame (104A, 104B) and door panel (105), which contains the lock assembly having a locking/closure assembly (113). The Figures depict a variety of types of residential and commercial lock assemblies in FIGS. 9-22. For ease of reference the different type of locking assembly is identified but not specifically named in connection with each Figure, though a person of ordinary skill in the art would appreciate the name and relevant functional features of each lock assembly based on the depiction in the Figures. It is understood that a single door panel may include one or more lock assemblies of FIGS. 9-22, two or more lock assemblies of FIGS. 9-22, three or more lock assemblies of FIGS. 9-22, or more than three lock assemblies of FIGS. 9-22. Also contemplated herein are systems and kits that include two or more door panels, each of the two or more door panels containing one or more of any of the lock assemblies of FIGS. 9-22.

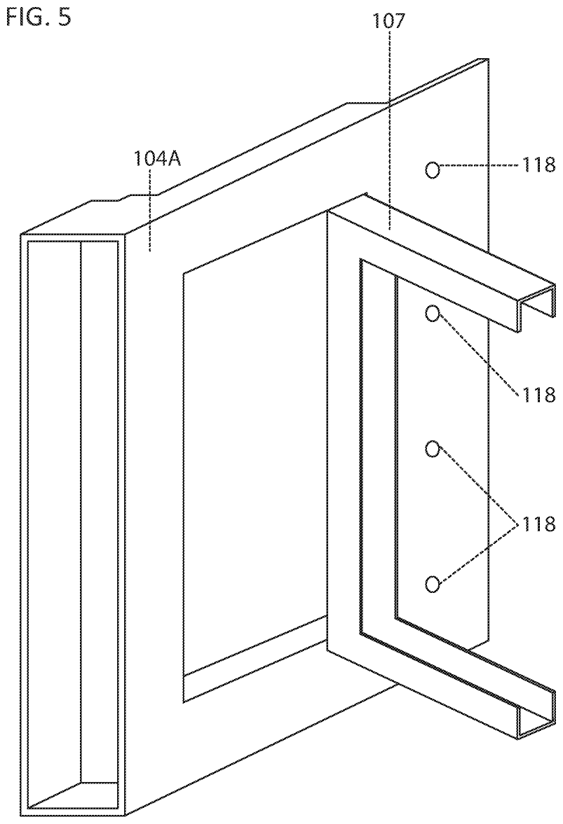

The door panel (105), with locking assembly hardware installed (113), is positioned in operable connection with the bracket (107). The bracket, in turn, is attached to the frame (104A, 104B). This attachment of the bracket with the frame is most frequently provided with a hinge (106) that permits the bracket to be rotated in one or more direction (e.g., to simulate the operation of a door). See, e.g., FIGS. 5-6, 25. In one exemplary embodiment the apparatus has a plurality (e.g., 2, 3, 4, 5, etc.) of attachment points (118), where it can be affixed to a post (102) or other mounting mechanism adapted to hold the working section without interfering with its operation. Examples of construction components include steel, wood, plastic, glass, composite, fiberglass, aluminum, or another metal or metal alloy.

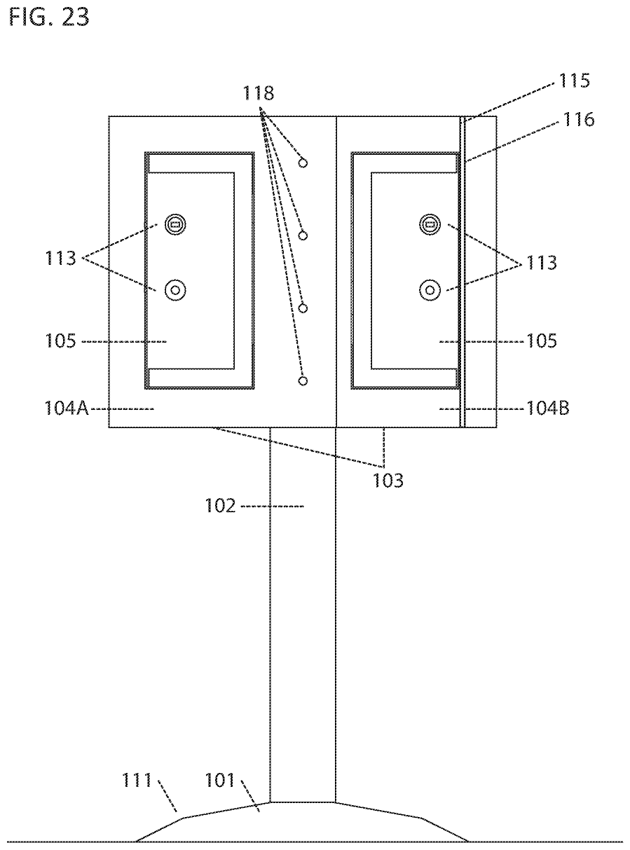

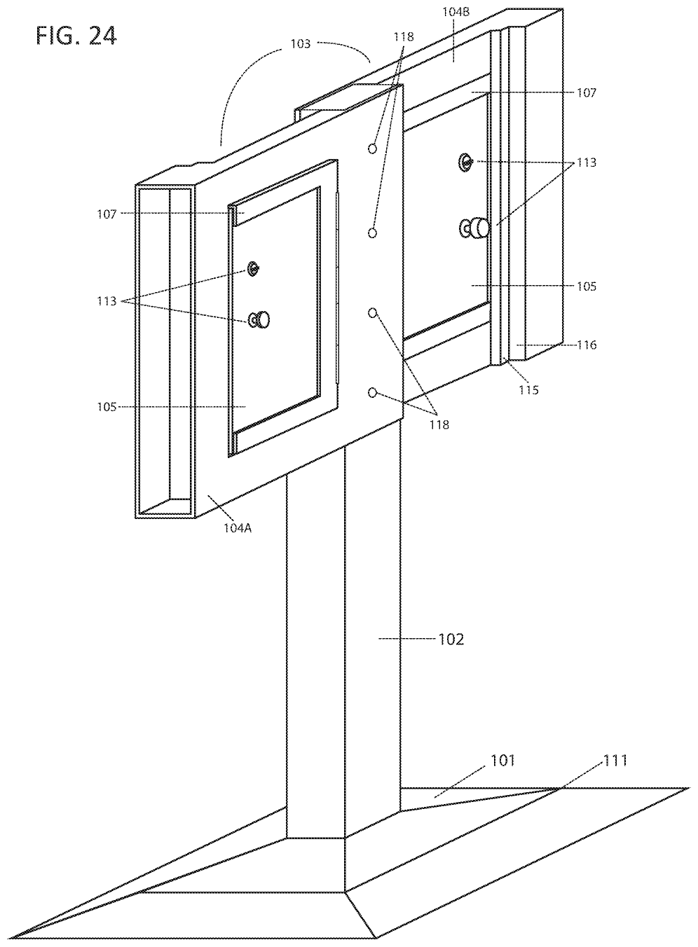

As depicted in FIGS. 23-24, two working sections (103) are fastened opposite and adjacent one another at the top of a post (102). The hinge (106) allows the system bracket (107) to simulate inward and outward opening doors. One side of the hinge is welded to the door jamb (108), and the other side of the hinge is welded to the system bracket (107), constructed for example using a steel U channel in a shape that accommodates the insertion and removal of one or more door panels, each optionally featuring any of a variety of locking assemblies (FIGS. 9-22).

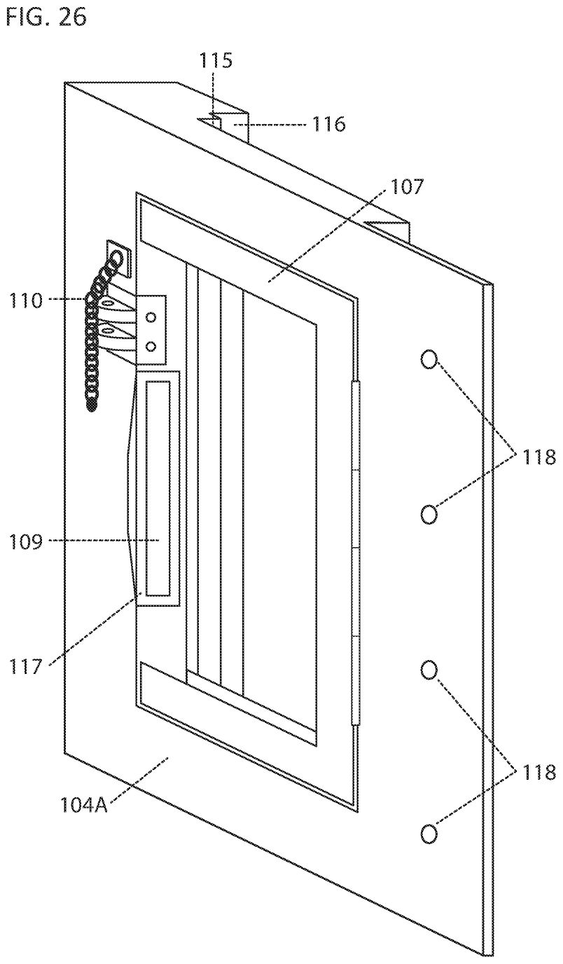

As depicted in FIG. 26, a lipped strike plate (117) is provided that is elongated, with an elongated opening (109) to accommodate interchangeable simulated door panels with different locking assemblies (FIGS. 9-22). The upper rabbet (110) above the strike plate also features spaces for lock assemblies such as a rim lock, door chain guard, privacy door latch, etc. One or more lock assemblies such as a rim locks, door chain guards, privacy door latches may be included in a variety of the embodiments contemplated herein, e.g., with the embodiments of FIGS. 9-22.

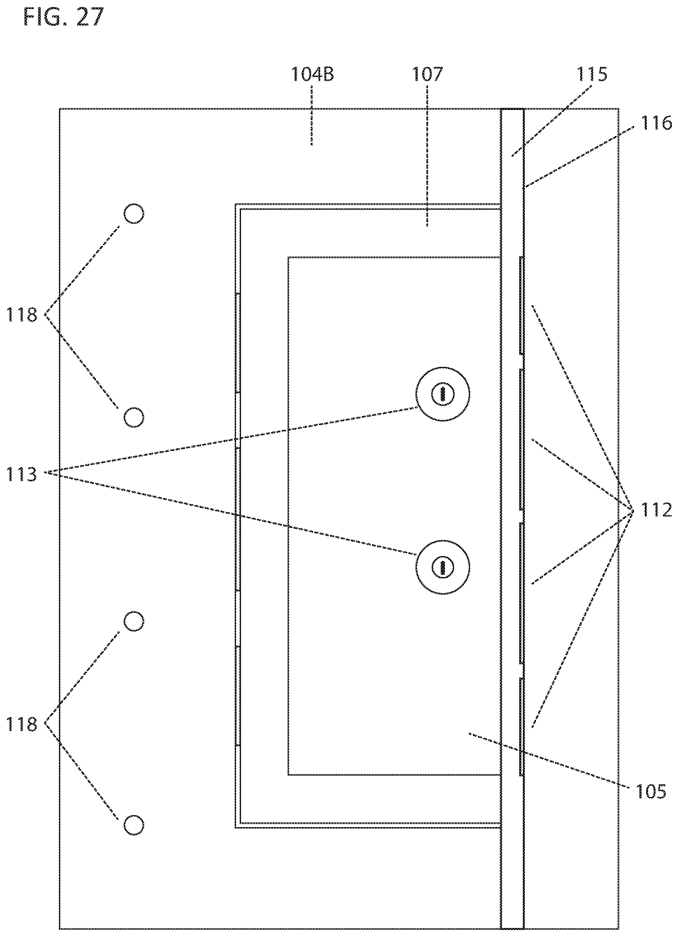

As depicted in FIG. 27, an exemplary steel doorstop (115) is welded to the jamb (116), while providing for sections of spacing (e.g., ⅛″) between the doorstop and the jamb (112). The purpose of this spacing is to simulate wood jamb/wood stop construction, in which the wood stop can be pried away from the wood jamb to provide space for a blade like tool to slide in and swipe the latch.

The door panel (105), as depicted in the embodiments of FIGS. 9-22, is often adapted to accommodate any of a variety of assemblies of opening/closing and/or lock assemblies (113). The door panel may be comprised of any suitable material, for example, metal, wood, composite, fiberglass, plastic. In frequent embodiments the door panel is metal such as steel, aluminum, iron, or another metal or metal alloy. In such embodiments the door panel is composed of a durable material that can withstand multiple uses and accommodate replacement/repair of locking assembly hardware over multiple uses without losing functionality or the ability to securely accept locking assembly hardware. Also, in frequent embodiments the door panel is wood, composite, fiberglass, plastic. According to certain embodiments, the door panel is of any size and/or shape suitable to the application such that it can accommodate the installation of the locking assembly hardware 113. As such, while rectangle-shaped door panels are depicted, this is for illustration purposes only.

In kits of the present systems, one or more door panels and/or one or more options for opening/closing and/or lock assembly hardware are included. Often, in presently contemplated kits two or more door panels and/or one or more options for opening/closing and/or lock assembly hardware are included. As described herein in connection with specific embodiments, the door panels of such kits are removably positionable in the one or more bracket of the working section of the kit. Further, the door panels (105) of the present disclosure may be comprised of any of a variety of types of materials and shapes and door construction, e.g., wood, metal, plastic, composite, or glass door panels.

In frequent embodiments the locking assembly hardware is installed in the door panel in a break-away manner. According to certain of such embodiments, the locking assembly hardware is installed in the door panel in a manner that permits the locking assembly hardware, including certain portions thereof, to break-away from the door panel under force without harming the door panel. Such embodiments typically utilize a metal door panel. In such embodiments the door panel is adapted to accept the locking assembly hardware in a manner that holds the hardware in the panel in a manner that withstands external forces equivalent to if the locking assembly had been installed in a wood (for example) door frame. Such external forces are such that when provided at a duration, nature and/or character that would cause the integrity of the securement of the locking assembly hardware to fail in a wood (for example) door frame. Such embodiments may be referred to herein as hybrid door panels. Such hybrid door panels permit the use of one material for the door frame and another material for holding the locking assembly hardware, thereby permitting preservation of the integrity of the door frame while accurately providing a lock hardware microenvironment that requires the same techniques, procedures and force to bypass as if the lock hardware was present in an entire door frame holding the locking assembly hardware. Such hybrid door panels are often used with the C-System described herein. According to these embodiments the locking assembly hardware (or portions thereof) are secured or otherwise provided in a mounting assembly, which mounting assembly is secured or otherwise provided in a door panel. This door panel is often mounted in the C-System described herein. The mounting assembly is provided using a mechanism and/or materials that provide a realistic representation of a predetermined door frame material as it relates to the actions and forces imparted to the hardware and door frame in a bypass procedure. This is regardless of the material used for the door frame supporting the mounting assembly. Such mounting assemblies therefore act/react as if the entire door frame was composed of the material that the mounting assembly is provided to mimic during a bypass procedure. Therefore, in such embodiments the door frame is often composed of a much more durable material (e.g., metal) than the mounting assembly (e.g., wood) that holds the locking assembly hardware.

In embodiments provided on a post (102) such as in FIG. 24, the post (102) supports the one or more (here two are depicted) working sections (103) at the top at attachment points (118) and is connected to the base (101) at the bottom. While attachment points (118) are depicted as holes for bolting the working section to the post, this is for illustration purposes only and done without limitation about the alternative embodiments for accomplishing attachment. For example, it is contemplated that any suitable mechanism for attachment of the working section to the post (102) is employed. In the embodiment depicted in FIG. 23, the base provides support for the post and two working sections and has a low tapered incline (111) to provide stability and a comfortable user experience. Fewer (e.g., 1) or more (e.g., 2, 3, 4, or more) working sections may be provided on the post. Each working section may be selected from the type of working section depicted in any of FIG. 1-22 or 25-27. Thus, the embodiment of FIGS. 23-24 include optional replacement of the working sections of one or more of FIG. 1-22 or 25-27. Though it is not depicted, in exemplary embodiments the post (102) is vertically adjustable such that the height of the one or more working sections may be adjusted vertically up or down on the Y-axis. Also optionally, the post (102) is angled to place the working section at a lateral angle or position relative to the post (102) (not depicted). Such embodiments may be positioned with the base (101) on the ground, a desk, or other elevated surface.

Alternatively, embodiments of the presently contemplated systems may be provided on a post (102) as contemplated herein and described above, though without a base. In such embodiments the post (102) is often mounted to another structure (e.g., floor, wall, desk, bench, vehicle, etc.). One or more working sections, such as those depicted in any of FIG. 1-22 or 25-27 are then attachable and removable from the post, for example, at an attachment point (118).

The present disclosure further contemplates training procedures to be used with the apparatus and systems of the present disclosure. For example, with the door panel of an exemplary apparatus closed and the lock assemblies in the locked position, the user conducts a multi-step reasoning process, which guides the use of the apparatus and procedures available to bypass the lock assemblies. This reasoning process may include purpose related questions such as: Why am I here?; What is the emergency?; What is the type of door construction, door frame components, and locking components?; What tools do I have at my disposal? If through-the-lock entry is the appropriate action, the user proceeds to utilize available tools to defeat the lock assemblies and open the door successfully.

In embodiments with two or more working sections (103), two or more users can work with the systems simultaneously.

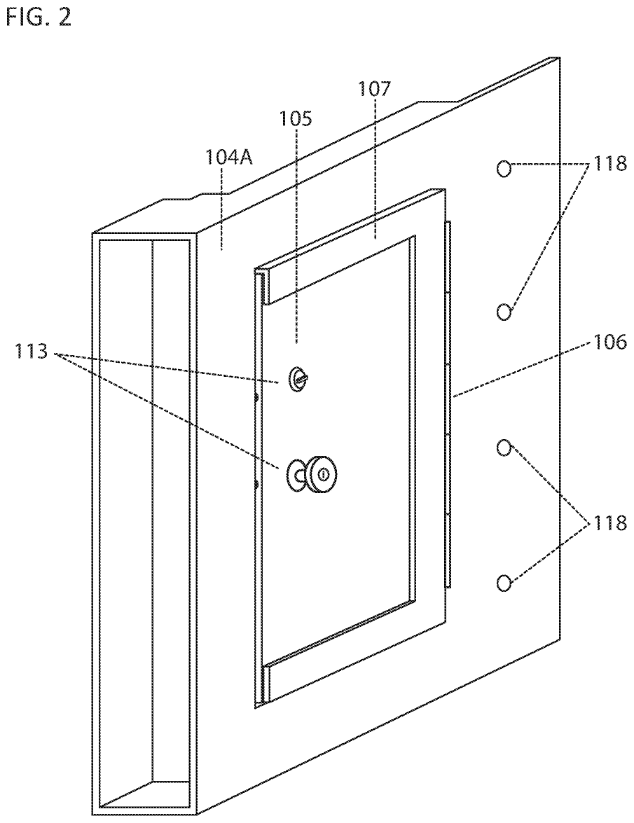

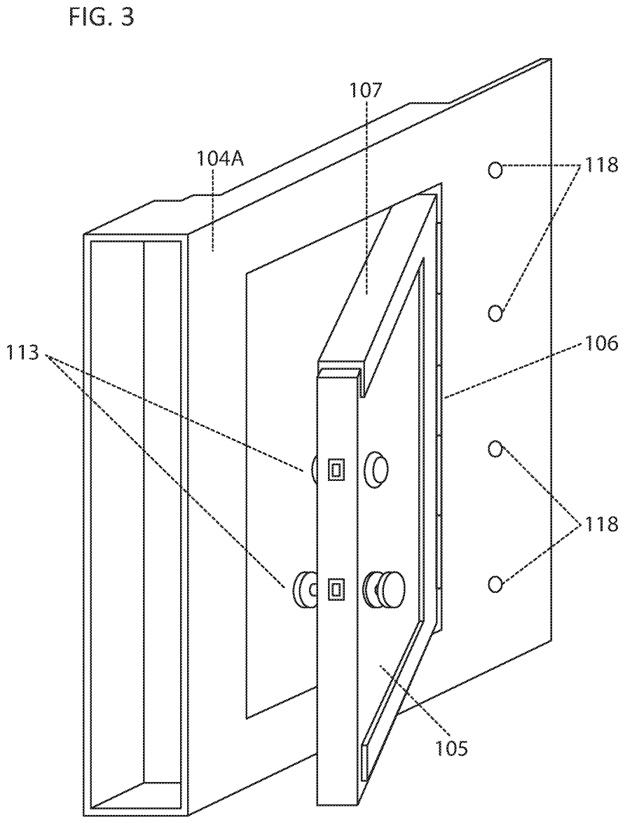

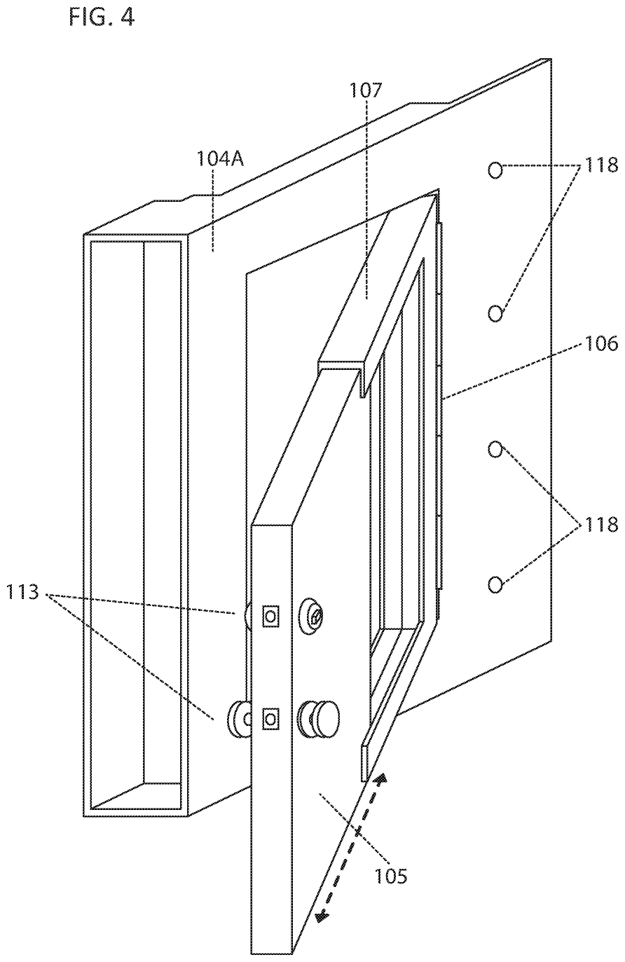

To work on different locking assemblies, the user opens the door panel (see, e.g., FIGS. 2-3), removes the door panel from the system bracket (FIGS. 4-6), and inserts a different door panel with a different locking assembly. The dotted arrow depicted in FIG. 4 shows the directions of positioning the door panel in, or removing the door panel from, the bracket (107). This is often the process of replacing door panels within the bracket.

When the door panel is inserted or otherwise connected with the bracket, it is securely held by the bracket. While not intending to be bound by any specific theory of operation, the bracket and the door panel of each of the presently contemplated embodiments are configured to securely interface with one another such that the door panel is removably positionable in connection with the bracket. In certain embodiments the door panel is slid into the bracket and a friction fit is provided. In other embodiments the bracket and door panel are secured using friction fit, gravity, one or more latch, one or more clip, adhesive, tape, deformable closure, shaped interface, one or more magnetic connection, etc. A kit will often include two or more replaceable door panels adapted to be securely positioned in connection with the bracket.

The system door panels can accommodate any of a variety of residential and/or commercial lock assemblies, making it a versatile prop for developing through-the-lock skills. In certain embodiments, a single door panel includes two or more lock assemblies. In certain embodiments the door panel is reversible, with one or more locking assembly on one side and one or more locking assembly on the other side. Depending on how the door panel is placed in the bracket, the locking assembly on either side may be operable for the methods contemplated herein.

The present disclosure contemplates kits for use in preparing and using the apparatus and systems described herein. One exemplary kit includes, for example, a base, a post, one or more working section door props featuring the system door panel bracket, one or more replacement system door panels, one or more residential lock assemblies, and one or more commercial lock assemblies. Another exemplary kit includes, for example, a base, a post, one or more working section door props featuring the system door panel bracket, two or more replacement system door panels, and two or more residential and/or commercial lock assemblies. Another exemplary kit includes, for example, a base, a post, two or more working section door props featuring the system door panel bracket, two or more replacement system door panels, and three or more residential and/or commercial lock assemblies. Embodiments of replacement kits often include one or more replacement system door panels, one or more residential lock assemblies, and/or one or more commercial lock assemblies.

The above examples are included for illustrative purposes only and are not intended to limit the scope of the disclosure. Many variations to those methods, systems, and devices described above are possible. Since modifications and variations to the examples described above will be apparent to those of skill in this art, it is intended that this disclosure be limited only by the scope of the appended claims.

One skilled in the art will appreciate further features and advantages of the presently disclosed methods, systems and devices based on the above-described embodiments. Accordingly, the presently disclosed methods, systems and devices are not to be limited by what has been particularly shown and described, except as indicated by the appended claims. All publications and references cited herein are expressly incorporated herein by reference in their entirety.

1. An apparatus comprising:
a working section door prop, wherein the working section door prop comprises a door frame and a bracket rotatably attached to the door frame;
a door panel, wherein the door panel is adapted to be mountably received by the bracket such that the door panel is secured by the bracket; and
a lock assembly comprising a locking mechanism secured in the door panel,
wherein the door frame is adapted to accept one or more type of lock assembly at one or more discreet locations.

2. The apparatus of claim 1, wherein a rotation of the rotatably attached bracket is at least 30 degrees.

3. The apparatus of claim 1, wherein the door panel is secured in a track formed by the bracket.

4. The apparatus of claim 1, wherein the bracket is C-shaped such that when a square door panel is secured in the bracket, the door frame is contacting, connected with, or secured by at least a portion of three sides of the square door panel.

5. The apparatus of claim 1, wherein the bracket forms a track adapted to removably receive the door panel.

6. The apparatus of claim 1, wherein the adaptation of the door frame to accept the one or more type of lock assembly comprises permitting reversibly securable closure and interface of the door panel with the door frame.

7. The apparatus of claim 1, wherein the door panel is secured by the bracket without additional hardware.

8. The apparatus of claim 1, wherein the working section door prop is mounted on a post or other mounting hardware.

9. The apparatus of claim 8, further comprising one or more additional working section door props mounted on the post or other mounting hardware.

10. The apparatus of claim 1, wherein the door panel is a hybrid door panel.

11. The apparatus of claim 10, further comprising a mounting assembly, and wherein the lock assembly is secured in the mounting assembly, and the mounting assembly is securely positioned in the hybrid door panel.

12. The apparatus of claim 11, wherein the hybrid door panel is composed of a different material than the mounting assembly.

13. The apparatus of claim 12, wherein the material of the hybrid door panel is metal and the material of the mounting assembly comprises wood, composite, and/or plastic.

14. The apparatus of claim 10, wherein the hybrid door panel is directly rotatably attached to the door frame without the bracket.

15. The apparatus of claim 1, wherein the one or more type of lock assembly comprises two or more different types of lock assemblies such that the door frame is adapted to accept the two or more types of lock assemblies at one or more discreet locations.

16. A training system, comprising the apparatus of claim 1, one more additional door panel, and one or more additional lock assembly.

17. The training system of claim 16, further comprising a mounting post, wherein the working section is adapted to be removably attached to the mounting post.

18. A training system, comprising the apparatus of claim 13, one more additional mounting assembly, and one or more additional lock assembly.

19. A training system, comprising the apparatus of claim 14, one more additional mounting assembly, and one or more additional lock assembly.
